(19) United States
(12) Patent Application Publication
(10) Pub. No.: US 2006/0165913 A1
(43) Pub. Date: Jul. 27, 2006

(54) Method of reducing number of particals on low-k material layer

(76) Inventors: Bella Chen, Kaohsiung City (TW); Chin-Hsiang Lin, Hsinchu City (TW); Chih-Chien Liu, Taipei (TW); Jerander Lai, Tainan City (TW)

Correspondence Address: J C PATENTS, INC., 4 VENTURE, SUITE 250, IRVINE, CA, 92618, US

(21) Appl. No.: 11/046,049

(22) Filed: Jan. 27, 2005

(51) Int. Cl. H05H 1/24

(52) U.S. Cl. 427/569

(57) ABSTRACT

A method of reducing the number of particles on a low-k material layer is described. The low-k material layer is formed by a plasma enhanced chemical vapor deposition process, wherein a reaction gas, a cleaning gas, a high-frequency power and a low-frequency power are used. The method comprises turning off the reaction gas and the low-frequency power after the low-k material layer is formed, and continuing to provide the cleaning gas during a delay time.

### BACKGROUND OF THE INVENTION

1. Field of the Invention

The present invention generally relates to a method of forming a low-dielectric constant (low-k) material layer. More particularly, the present invention relates to a method of reducing the number of particles on a low-k material layer.

2. Description of Related Art

As the dimension of the Ultra-Large Scale Integration (ULSI) continues to shrink, the Resistance-Capacitance-Delay caused by the multi-layer inner metal connectors not only limits the high speed operation but also increases power consumption, increasing temperature of the chips. Dielectric layers made of low-dielectric constant material can be disposed between the multi-layer inner metal connectors to shorten the time for resistance-capacitance delay.

Nowadays, many low-k materials are formed by the plasma enhanced chemical vapor disposition method, including a material called HARD-CORAL, which uses the tetra-methyl-cyclo-tetra-siloxane (TMCTS) as reaction gas. After the low-k material layer reaches the pre-determined thickness and the source for the TMCTS gas is turned off, however, the remaining TMCTS gas would continue a deposition process, generating particles thereon. As a result, extra time and efforts are needed to fix the particles before mass production, thus the completion date of products will be affected.

In solution, a method to improve the particle defect during the deposition of the low-k material. In the method, a reduced low frequency power (LF power) and a reduced high frequency power (HF power) are supplied during a delay time after the source of the reaction gas is turned off. Accordingly, the number of the particles will decrease.

FIG. 1 is the top view of the low-k material layer formed by the abovementioned deposition method. As shown in FIG. 1, although the number of the particles is reduced, however, the average number per unit area is still as many as 9697, which still affects the subsequent manufacturing process.

### SUMMARY OF THE INVENTION

Accordingly, the present invention is directed to a method of reducing the number of particles on the low-k material layer, thereby improving the film quality and overall yield.

In the method of reducing the number of particles on a low-k material layer according to the present invention, the low-k material layer is formed by the plasma enhanced chemical vapor deposition method. Wherein, a reaction gas, a cleaning gas, a high frequency power and a low frequency power are used during the deposition process. The method comprises turning off a source of the reaction gas and low-frequency power after the low-k material layer is formed, and continuing to provide the cleaning gas during a delay time.

According to an embodiment of the present invention, the value of the high frequency power during the delay time, is equal to or lower than that during the deposition period of the low-k material layer. Alternatively, the high frequency power is completely turned off and the pressure is reduced to achieve the same effect of reducing the particles.

According to an embodiment of the present invention, the reaction gas comprises tetra-methyl-cyclo-siloxane.

By applying the method of the present invention, the number of the particles on the low-k material layer can be reduced, the quality of the film is improved, and the yield rate is increased.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is the top view of the low-k material layer formed by the conventional deposition process.

FIG. 2 is the top view of the low-k material layer formed the deposition process according to one embodiment of the present invention.

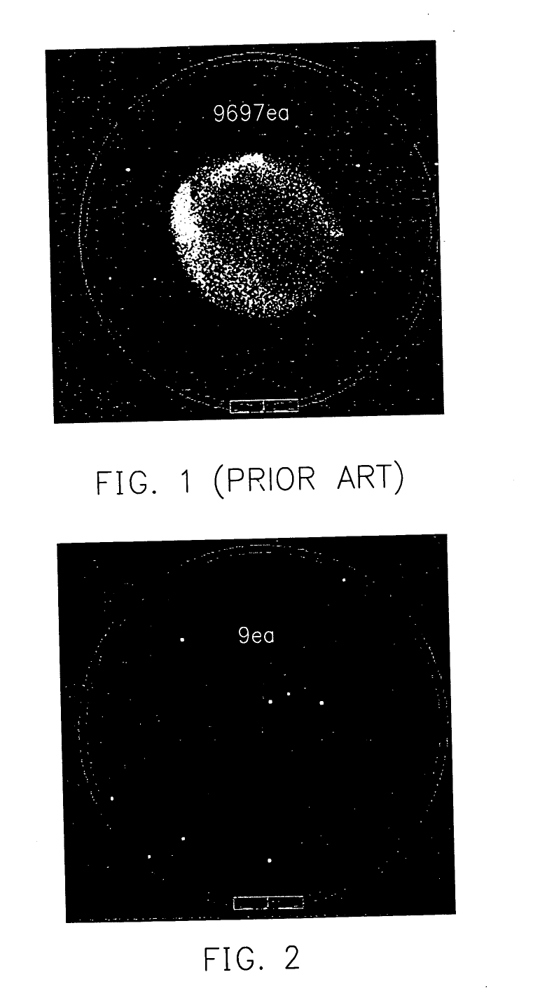

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

The reaction gas in the present embodiment is the tetra-methyl-cyclo-siloxane (TMCTS), provided by a liquid TMCTS system, which is then gasified. The flow rate for the normal deposition period is about 1.5˜6.5 sccm.

The cleaning gas used herein is, for example, carbon dioxide. The flow rate for the carbon dioxide cleaning gas during the normal deposition period is about 3,000˜12,000 sccm. Wherein the high frequency power is in the range of 700˜1,500 W, and the low frequency power is under 800 W with the frequency in the range of 350˜450 Hz. Additionally, the temperature for the plasma enhanced chemical vapor decomposition process is 350˜450° C. and the operation pressure is in the range of about 2.5˜5 Torr.

Next, after the low-k material layer reaches a pre-determined thickness, TMCTS gas source and low frequency power are turned off but the cleaning gas is provided during a delay time. The delay time is, for example, 1 to 5 seconds and the high frequency power during the delay time is under 1500 W. Alternatively, the high frequency power is completely turned off and the pressure is reduced, which can also reduce the number of particles. In addition, the flow rate for the carbon dioxide cleaning gas during the delay time is about, for example, 6,000˜10,000 sccm to clean the particles.

FIG. 2 is a top view of the low-k material layer formed by a deposition process according to an embodiment of the present invention. As shown in FIG. 2, it is obvious that the preset invention can effectively reduce the number of particles, so only 9 particles can be seen on the low-k material layer.

As above mentioned, the method of the present invention can reduce the number of particle on the low-k material layer. In addition, the film quality can be greatly improved, and the yield can be increased.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of reducing the number of particles on a low-k material layer, the low-k material layer being formed by a plasma enhanced chemical vapour deposition method, using a reaction gas, a cleaning gas, a high-frequency power and a low-frequency power, the method comprising:
turning off the source of the reaction gas and the low-frequency power after the low-k material layer is formed, and continuing to supply a cleaning gas during a delay time.

2. A method of reducing the number of particles on a low-k material layer as recited in claim 1, wherein the value for the high frequency power during the delay time is equal to or lower than that during the deposition process in forming the low-k material layer.

3. A method of reducing the number of particles on a low-k material layer as recited in claim 1, wherein the high frequency power is turned off, and the pressure is reduced.

4. A method of reducing the number of particles on a low-k material layer as recited in claim 1, wherein the reaction gas comprises tetra-methyl-cyclo-tetra-siloxane.

5. A method of reducing the number of particles on a low-k material layer as recited in claim 4, wherein the reaction gas is gasified from the liquid tetra-methyl-cyclo-tetra-siloxane system.

6. A method of reducing the number of particles on a low-k material layer as recited in claim 4, wherein the delay time is in a range from about 1 to 5 seconds.

7. A method of reducing the number of particles on a low-k material layer as recited in claim 4, wherein the cleaning gas comprises carbon dioxide.

8. A method of reducing the number of particles on a low-k material layer as recited in claim 7, wherein the flow rate for the cleaning gas during the delay time is from about 6,000 to 10,000 sccm.

9. A method of reducing the number of particles on a low-k material layer as recited in claim 4, wherein the high frequency power is turned off during the delay time.

10. A method of reducing the number of particles on a low-k material layer as recited in claim 4, wherein the high frequency power is under 1,500 W.

11. A method of reducing the number of particles on a low-k material layer as recited in claim 4, wherein the frequency of the low frequency power is in a range from about 350 to 450 Hz.

12. A method of reducing the number of particles on a low-k material layer as recited in claim 4, wherein the temperature during the plasma enhanced chemical vapour deposition process is in a range from about 350 to 450° C.

13. A method of reducing the number of particles on a low-k material layer as recited in claim 4, wherein the pressure of the plasma enhanced chemical vapour deposition process is in a range from about 2.5 to 5 Torr.
